(19) United States
(12) Patent Application Publication
(10) Pub. No.: US 2022/0361658 A1
(43) Pub. Date: Nov. 17, 2022

(54) Comprehensive and Personalized Oral Care System and Method of Use Thereof

(71) Applicant: Jorgen Bech, Northbrook, IL (US)

(72) Inventor: Jorgen Bech, Northbrook, IL (US)

(21) Appl. No.: 17/732,801

(22) Filed: Apr. 29, 2022

Related U.S. Application Data
(60) Provisional application No. 63/188,671, filed on May 14, 2021.

(51) Int. Cl. A46B 9/04; A61C 17/22; A61C 17/20; A61C 17/032

(52) U.S. Cl. CPC A46B 9/045; A61C 17/228; A61C 17/222; A61C 17/20; A61C 17/227; A61C 17/032; A46B 2200/1066

(57) ABSTRACT

The present invention relates to a comprehensive oral care system. The oral care system provides users with an improved dental cleaning system to ensure people can practice optimal oral care routines. The system has an extendable mouthpiece for receiving the teeth and the tongue of a user. The mouthpiece has a plurality of brushes, and more specifically, three brushes for each tooth for brushing. The mouthpiece also releases water, dental rinse agents, and mouthwash for providing complete oral care. The system has a touch panel that can be used for configuration of parameters like speed and pressure of brushes, amount of water, dental rinse agents and mouthwash and other solutions for meeting requirements of individual users. The system uses a digitized dental mold for configuration and generation of the mouthpiece to create a replica of the jaw of users.

### CROSS-REFERENCE TO RELATED APPLICATION

The present application claims priority to, and the benefit of, U.S. Provisional Application No. 63/188,671, which was filed on May 14, 2021, and is incorporated herein by reference in its entirety.

### FIELD OF THE INVENTION

The present invention relates generally to the field of oral hygiene care and maintenance. More specifically, the present invention relates to a stationary, handheld or wall-mounted comprehensive oral care system. In one embodiment, the system includes a wall-mounted unit allowing users to brush, floss, rinse and utilize mouthwash without manually using a brush and dental floss. The system provides tailored brushes, or those designed to be unique, to individual users, supplies toothpaste and mouthwash for the individual user. A user puts their mouth, jaws and tongue in a mouthpiece for optimal oral care and treatment. A touchscreen panel allows users to adjust oral care parameters as per the individual needs of each user. Each user sets or establishes the various parameters of the system through use of the interface which provides a number of options for the individual to select. Accordingly, the present disclosure makes specific reference thereto. Nonetheless, it is to be appreciated that aspects of the present invention are also equally applicable to other like applications, devices and methods of manufacture.

### BACKGROUND

By way of background, teeth, tongues and the mouth provide a natural habitat for microbial growth in the fluid environment of the mouth cavity and gingival crevices. Germs and bacteria are also found on the gums, as well as the roof of the mouth. Certain types of microorganisms foster periodontal disease which affects the gums, causing them to gradually separate away from the infected root surfaces of the tooth. Bacteria, acid, food debris, and saliva combine in the mouth to form plaque which adheres to the teeth, tongue, and gum surfaces. Plaque accumulation causes inflammation of the gums, or gingivitis, and can progress to destruction of the ligaments and bone that support the teeth. Corrective action can be painful for the individual to restore the gums.

It is well known that brushing, flossing, and rinsing with mouthwash aid in maintaining oral hygiene, prevention of tooth decay and disease. However, standard manual and automated toothbrushes are not effectively used by people and also may be difficult to use. People may not use the toothbrush appropriately or for a sufficient period of time, which is around two minutes. Manual toothbrushes require effort, skill and brushing force which can damage teeth if the individual is overly vigorous in their brushing routines. Electric toothbrushes are bulky, more expensive than manual toothbrushes, difficult to maneuver, require battery replacement or recharging. People with physical limitations may not be able to use either manual or electric toothbrushes. Further, many people do not brush their teeth for the suggested period of time; and therefore, may leave germs, microorganisms, and plaque on teeth, which may lead to deterioration of an individual's teeth. In addition to brushing, dental floss and various antiseptic or antibacterial rinse solutions are an option; however, people often forget to perform these additional oral hygiene care methods. Further, such efforts are time-consuming and cumbersome. Dental professionals recommend brushing twice a day or after meals and flossing daily. The recommended brushing time is about two minutes. However, most people do not have the inclination to brush after each meal or spend the recommended time brushing. Those with sensitive teeth or irritated gums may avoid proper care of the affected areas due to the pain brushing may cause.

Especially, for children, maintaining oral hygiene is extremely difficult. Children do not brush their teeth effectively and do not perform flossing and rinsing potentially leading to cavities and ineffective oral care. As a result, people end up going for professional treatment by a dentist for themselves, or for their children. They may be left with expensive dental bills and the requirement for follow-up visits to a dentist.

Standard oral hygiene systems are not tailored or designed to meet an individual's mouth, and thus, may not be completely effective. The softness of bristles, the shape of bristles and other characteristics may not meet the preferences of individuals. Therefore, people seek a system that can provide personalized oral care and appropriate cleaning.

Therefore, there exists a long-felt need in the art for an oral care system that provides comprehensive oral care for people of all age groups. There is also a long-felt need in the art for a comprehensive dental cleaning system that allows people to conveniently practice optimal oral care routines. Additionally, there is a long-felt need in the art for a dental cleaning system that allows users to brush, floss, and utilize mouthwash and other dental rinses. Moreover, there is a long-felt need in the art for a multi-functional oral care system that eliminates the need to use manual and electric toothbrushes. Further, there is a long-felt need in the art for a dental care system that can be customized for an individual's mouth. Furthermore, there is a long-felt need in the art for an oral care system that allows users to adjust and select from a number of different settings, such as water pressure, temperature, brush pressure, speed, amount of toothpaste, and type of rinses or other solutions. Finally, there is a long-felt need in the art for a comprehensive dental cleaning system that uses a computerized operating system tailored or designed to fit the contours of an individual's mouth for maintaining oral hygiene.

The subject matter disclosed and claimed herein, in one embodiment thereof, comprises an automatic and comprehensive oral care system. The system allows users to brush, floss, and utilize mouthwash and other rinses for optimal oral care. The system further comprises a stationary, handheld or wall-mounted unit including a mouthpiece connected to an extendable and flexible arm and a touchscreen panel for entering information or selections for the treatment. The mouthpiece is tailored to fit a jaw of a user and has an upper jaw portion, a lower jaw portion and a tongue receptacle or receiving slot. In use, an individual places his or her teeth of upper jaw in the upper jaw portion and puts his or her teeth of lower jaw in the lower jaw portion. The tongue is put in the receptacle. A plurality of brush heads are positioned in the upper jaw portion, the lower jaw portion and the receptacle, such that the brush heads are positioned for each tooth and each brush is preferably slightly larger than the size of the tooth. The brushes are selected by an algorithm based on analysis of a digitized jaw mold of the user, which is submitted as part of the design activity. A plurality of holes are positioned inside the brushes of the upper portion and the lower portion for releasing rinsing fluids and mouthwash. The touchscreen panel is used for adjusting at least one treatment parameter, such as the rotating speed of brushes, speed of flossing water, amount of dispensed toothpaste, or quantity of mouthwash or other rinsing fluids.

In this manner, the novel dental care system of the present invention accomplishes all of the foregoing objectives and provides users with an improved dental cleaning surface to ensure people can practice and receive optimal oral care routines. The system eliminates the need for manual use of brushes, floss and mouthwash. Further, the cleaning regime is tailored or designed to meet the requirements of users, and brushes are selected in accordance with the size of the teeth of the individual for whom the system is designed for.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a comprehensive oral care system. The system further includes a unit or housing that has a mouthpiece connected to an extendable and flexible arm and a touchscreen panel. The mouthpiece is tailored to fit snuggly to a jaw of a user allowing the user to put or place his or her upper jaw in an upper jaw portion of the mouthpiece and put his or her lower jaw in the lower jaw portion of the mouthpiece. A receptacle is positioned between the upper jaw portion and the lower jaw portion for receiving the tongue of the user. A plurality of brushes or brush heads are positioned in the upper jaw portion, the lower jaw portion and the receptacle, and are capable of independent movement, such as rotation, horizontal, and vertical movement. The brushes are selected by an algorithm based on analysis of a digitized jaw mold of the user. A plurality of holes are provided inside the brushes or brush heads of the upper portion and the lower portion for releasing a dental rinse, mouthwash or other solution, such as a teeth whitening solution. The touchscreen panel may be used for adjusting at least one of the rotating speed of brushes, the speed of the dental rinse, the amount of toothpaste to be dispensed and/or the quantity of mouthwash.

In yet another embodiment, the mouthpiece is adjustable and is positioned in a desired position by extending the extendable and flexible arm. The mouthpiece is adjustable around a joint to further provide comfort for the user.

In yet another embodiment, the system has an integrated controller for controlling the operation of the system.

In yet another embodiment, the system having a housing is mounted in a wall using the wall-mounted unit.

In yet another embodiment, a comprehensive oral care system is disclosed. The oral care system includes a controller for selecting an algorithm for configuring at least one of: the amount of dental rinse solution, the amount of toothpaste to be dispensed, the quantity of mouthwash, the types and number of brushes or combinations thereof. A particular algorithm is selected from a plurality of algorithms and the controller selects the algorithm for use. The controller uses a digitized form of a dental mold created for an individual user for selecting the algorithm to create the dental care session. A mouthpiece using selected brushes chooses one of: a release of a selected quantity of the dental rinse fluid, an amount of toothpaste, and the quantity of mouthwash for cleaning the teeth of the user after an upper jaw portion of the mouthpiece receives the upper jaw of the user, a lower jaw portion of the mouthpiece receives the lower jaw of the user, and a receptacle receives the tongue of the user.

In yet another embodiment, a method of providing optimal oral care to a user is described. The method includes the steps of forming a digital dental mold of a user based on the dimensions of the mouth of the user and then selecting an algorithm based on analysis of the digital dental mold. The mouthpiece, which has been tailored to the individual, is used for receiving teeth and the tongue of the user. Next, the teeth of the user are brushed using brushes disposed inside the mouthpiece and simultaneously cleaning the tongue using brushes disposed in the tongue cleaning portion of the mouthpiece. A dental rinsing agent is released at an appropriate speed for flossing and releasing mouthwash for providing a complete oral healthcare.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the comprehensive oral care system of the present invention in accordance with the disclosed architecture;

FIG. 2 illustrates a functional block diagram showing how one potential embodiment of the comprehensive oral care system of the present invention is tailored to the mouth of a user in accordance with the disclosed architecture;

FIG. 3A illustrates a perspective view of teeth being brushed using the brushes in the upper portion and lower portion of the mouthpiece of one potential embodiment of the dental care system of the present invention in accordance with the disclosed architecture;

FIG. 3B illustrates a perspective view of teeth being flossed by one potential embodiment of the dental care system of the present invention in accordance with the disclosed architecture;

FIG. 4 illustrates a flow diagram depicting a process of use of one potential embodiment of the dental care system of the present invention in accordance with the disclosed architecture; and

FIG. 5 illustrates a perspective view showing a user using one potential embodiment of the dental care system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an oral care system that provides comprehensive oral care for individuals of all age groups. There is also a long-felt need in the art for a comprehensive dental cleaning system that allows people to practice optimal oral care routines. Additionally, there is a long-felt need in the art for a dental cleaning system that allows users to brush, floss, and utilize mouthwash and other dental solutions. Moreover, there is a long-felt need in the art for a multi-functional oral care system that eliminates the need for the use of manual and electric toothbrushes. Further, there is a long-felt need in the art for a dental care system that can be customized and uniquely designed for an individual's mouth. Furthermore, there is a long-felt need in the art for an oral care system that allows users to adjust and select a variety of settings like water pressure, temperature, brush pressure, speed, amount of toothpaste, dental rinses, and combinations thereof. Finally, there is a long-felt need in the art for a comprehensive dental cleaning system that uses a computerized operating system tailored to fit an individual's mouth for maintaining oral hygiene.

The present invention, in one exemplary embodiment, is a comprehensive oral care system. The oral care system includes a controller for selecting an algorithm for configuring at least one of: the amount of floss water, amount of toothpaste, quantity of mouthwash, types and number of brushes, and various combinations thereof. An algorithm database stores a plurality of algorithms and a controller selects the algorithm. The controller uses a digitized form of a dental mold of a user for selecting the algorithm. A mouthpiece has a number of pre-selected brushes or brush types and then releases a selected quantity of the dental rinse agent, the amount of toothpaste, and the quantity of mouthwash for cleaning the teeth of the user after an upper jaw portion of the mouthpiece receives the upper jaw of the user, a lower jaw portion of the mouthpiece receives the lower jaw of the user, and a receptacle receives the tongue of the user.

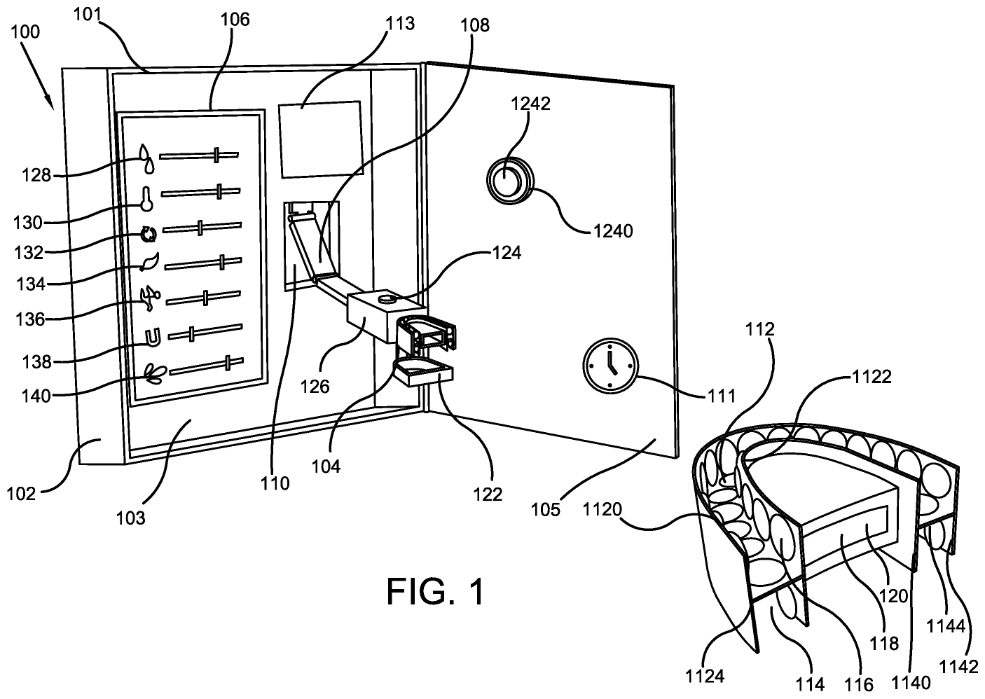

Referring initially to the drawings, FIG. 1 illustrates a perspective view of one potential embodiment of the comprehensive oral care system of the present invention in accordance with the disclosed specification. The comprehensive oral care system 100 of the present embodiment has a housing 101 which includes a cabinet area 103 with a door 105 to conceal the interior of the cabinet and contents. The housing 101 may be a handheld or wall-mounted oral care system and can be mounted at any appropriate place inside a home or any other area or place upright on a surface, such as a table. More specifically, the system 100 includes a stationary housing 101 such as a wall-mounted unit 102 that includes an extendable and flexible mouthpiece 104 and a touch panel 106. The mouthpiece 104 is attached to an extendable and flexible arm 108 which is extended from a cavity 110 in the cabinet 103 in the unit 102. The mouthpiece 104 is configured to receive the teeth of both the upper jaw and lower jaw of a user and utilizes a collection of brushes, such as three, one brush on each side of the tooth and one over the top of the tooth for cleaning. The mouthpiece also features a water flossing system, mouthwash dispenser, and other dental and cosmetic solutions, such as whitening agents, for providing comprehensive oral cleaning. The housing 101 may also include a mirror 113 so that the user can watch the oral care cleaning session as well as a clock 111, which may include an alarm, so that the user is aware of the duration of the cleaning session.

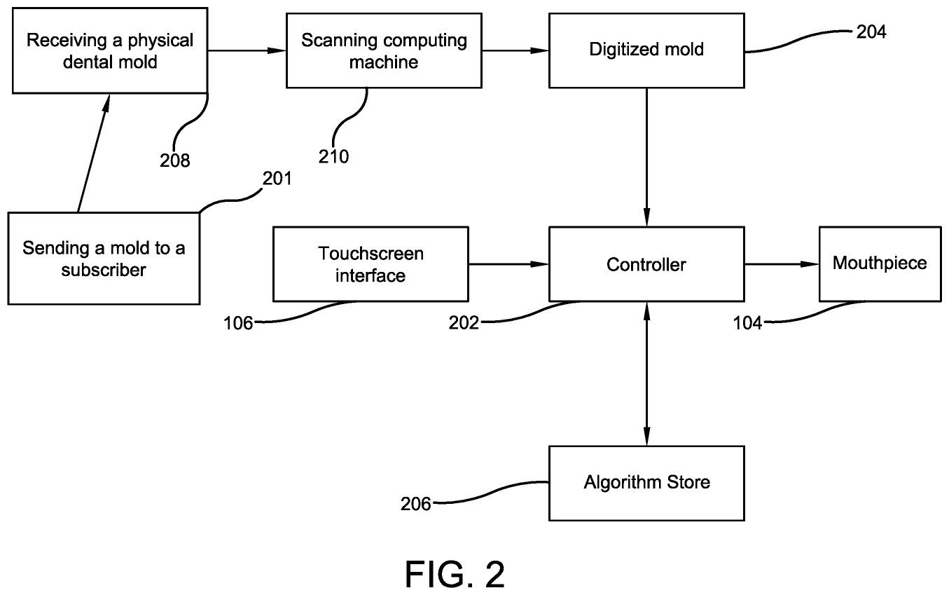

More specifically, an upper portion 112 of the mouthpiece 104 receives teeth in the upper jaw of a user and a lower portion 114 receives the teeth in the lower jaw. Both the upper portion 112 and the lower portion 114 have brushes 116 for providing teeth cleansing. The upper portion 112 has a pair of vertical walls 1120, 1122 and an intermediate wall 1124. The walls 1120, 1122, 1124 allow a tooth of the upper jaw of a user to be exposed to three brushes positioned on the walls and thus provide an effective cleaning of each of the teeth of the user. The brushes 116 are mounted via a series of custom wires that match the entire contour of a user's tooth lines as described in FIG. 2. Similarly, the lower portion 114 has a pair of vertical walls 1140, 1142 and an intermediate wall 1144. The walls 1140, 1142, 1144 allow a tooth of the lower jaw of the user to expose to three brushes positioned on said walls and thus provide an effective cleaning. The brushes 116 on the lower portion 114 are mounted via a series of custom wires that match the entire contour of a user's tooth lines as described in FIG. 2. It should be noted that the mouthpiece 104 has ninety-six brush heads for the teeth, and are round and slightly larger than the tooth they are assigned to. That is, there are a number of different sized brushes used to clean the teeth as there are different sized teeth within the mouth of a user.

For cleaning of the tongue, a receptacle 118 is positioned between the upper portion 112 and the lower portion 114. The receptacle 118 is configured to receive the tongue of a user and has brushes 120 inside the receptacle 118 for cleaning the tongue. The system 100 performs simultaneous cleaning of teeth and tongue for an effective and quick dental cleaning. The cleaning session may be started by a sensor once the tongue and teeth are in position in the mouthpiece 104 and the clock 111 may be started. The alarm will then stop the cleaning session after a pre-determined amount of time has elapsed, such as two minutes, which is the amount of time recommended by the American Dental Association.

A drip tray 122 is provided for collecting fluid from the mouth after cleaning of the teeth and tongue. The drip tray 122 is movable and is made from stainless steel or heavy-duty plastic. The drip tray 122 may also be used for supporting the chin of a user. A toggle button 124 is positioned on the anterior end 126 of the mouthpiece 104 allowing the mouthwash to release when the toggle button 124 is pushed in the position 1240 and for releasing a dental rinse agent when the toggle button 124 is pushed in the position 1242.

A touch screen interface 106 is positioned in the handheld or wall-mounted unit 102 and is used for configuration of the oral care system 100. The touch screen 106 provides a plurality of controls for controlling and adjusting the parameters to provide effective oral care cleaning of a user. More specifically, the water pressure control 128 is used for controlling and adjusting pressure of the dental rinse agent released by the system through at least one hole positioned in the mouthpiece 104. Preferably, at least one hole is positioned in both the upper portion 112 and the lower portion 114. A temperature control 130 adjusts the temperature of the rinse agent and is useful for people to control temperature as per their preferences. A brush pressure control 132 adjusts the pressure exerted on the teeth during operation of the system 100 for cleaning the brush. Less pressure may be desired by people having weak gums, and the pressure can be adjusted using the slider of the control 132. A brush speed control 134 controls the rotational speed of the brushes for cleaning the teeth. A toothpaste amount control 136 controls the quantity of toothpaste dispensed by the system. The control 136 can be configured to release different amounts of toothpaste, such as for children and adults, and prevents it from dispensing too much or an inappropriate amount of toothpaste based on the user. A mouthwash amount control 138 works in a similar manner to the toothpaste amount control 136 and is used for adjusting the amount of mouthwash released by the system 100. An activation control 140 can be used for activating or deactivating the system 100 and allows a user to selectively start the cleaning operation by the mouthpiece 104.

It should be noted that during installation of the system 100, the touch panel interface 106 is coupled to the mouthpiece 104 and the extendable arm 108. The touch panel interface 106 has an integrated controller (shown in FIG. 2) for controlling operation of the mouthpiece 104.

FIG. 2 illustrates a functional block diagram showing how the system 100 of the present invention is tailored to the needs of a user in accordance with the disclosed specification. As illustrated, the system 100 has a controller 202 for controlling operation of the system 100 for providing effective oral healthcare for users. The controller 202 can be any type of processor, controller or combination of processors capable of executing various software commands or driving firmware, such as one or more microprocessors, digital signal processors, microcontrollers, or the like. The controller 202 may be a single processor or may include multiple processors. The controller 202 receives input of adjustment of various parameters for working of the system 100 (as described in FIG. 1) from the touchscreen interface 106, and accordingly actuates and controls operation of the mouthpiece 104.

For providing a tailored and customized cleaning for a user, the system 100 uses the mouthpiece that is an exact replica of the jaw and mouth shape of the user. For creating a customized mouthpiece for a user, a dental molding kit is sent to the user 201, and a physical dental mold 208 is received from the user. Before installing the system 100, the dental mold is digitized using a scanning computing machine 210 and the digitized mold 204 is used by the controller 202 for selecting at least one algorithm from a dental cleaning algorithm database 206 for creating a customized cleaning regime for the user. The chosen algorithm configures the parameters provided on the physical screen interface 106, such as j aw size, tooth size, number of teeth, absence of teeth, dental implants, abscesses and other characteristics that may be present in the mouth of the subscriber. As a result, the algorithms provide a customized and personalized dental cleansing system using the personalized mold installed as the mouthpiece. The controller and the algorithm also help in assigning the best brush types, such as degree of hardness, type of bristles, arrangement of bristles and combinations thereof, by ascertaining the quality of teeth and gums of a user. Further, the brushes are mounted via a series of custom wires that match the entire contour of the user's tooth line. While three brushes or brush heads may be associated with each tooth, the brushes may not be the same configuration as two brushes are working on the side walls of the teeth and the other brush is working on the top of the tooth; therefore, the brushes are working on different topography. In addition, there are different types of teeth, such as molars, incisors and the like. As such, different types of brushes or brush heads may be used.

The algorithm database 206 may use machine learning modules for learning the changes and adjustments made by a user on the interface 106 and can use the machine learning for improving the configuration done at the time of installation of the system 100 and alignment of brushes with the teeth and amount of toothpaste and rinse materials that are released. The controller 202 is configured to control the overall operation of the system 100 based on instructions of users using the touchscreen interface 106.

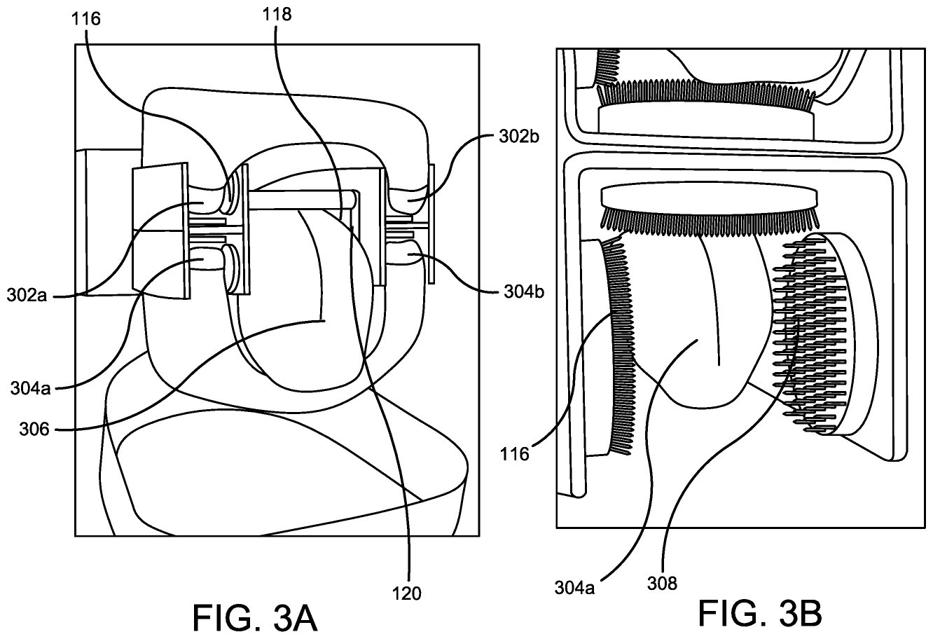

FIG. 3A illustrates a close up view of teeth being brushed and using the brushes in the upper portion and lower portion of the mouthpiece of the dental care system 100 in accordance with the disclosed specification. As illustrated, teeth 302a, 302b of the upper jaw are positioned between the brushes in the upper portion 112. The teeth 302a, 302b are exposed to a number of brushes such as three brushes (for each tooth) supported by the walls 1120, 1122, 1124. The brushes positioned for the teeth 302a, 302b work simultaneously to brush the teeth 302a, 302b.

Similarly, teeth 304a, 304b of the lower jaw of a user are positioned between the brushes 116 in the lower portion 114. All the brushes are positioned on the walls 1140, 1142, 1144 for brushing the teeth 304a, 304b thereby preventing formation of plaque or the spread of disease. As shown partially, the tongue 306 is placed in the receptacle 118 and brushes 120 positioned inside the receptacle 118 are used for effectively cleaning the tongue 306. It should be appreciated that the system 100 cleanses teeth and the tongue of a user effectively and simultaneously.

FIG. 3B illustrates a close view of teeth being flossed by the dental care system 100 in accordance with the disclosed architecture. As illustrated, the exemplary tooth 304a is flossed by water or other dental rinse agents being ejected from small holes 308 in the brushes 116. The pressure and flow of the flossing water is set using the touch interface panel 106 as described in FIG. 1. Similarly, the teeth of upper jaw and positioned in the upper portion are flossed by the brushes.

The drip tray (shown in FIGS. 1 & 3A) can be used to accumulate the flossing water or rinse agents which may fall out of the mouth. Similar to the flossing water, mouthwash used for cleaning the teeth both in the upper portion and the lower portion is accumulated or collected in the drip tray along with other dental solutions and saliva.

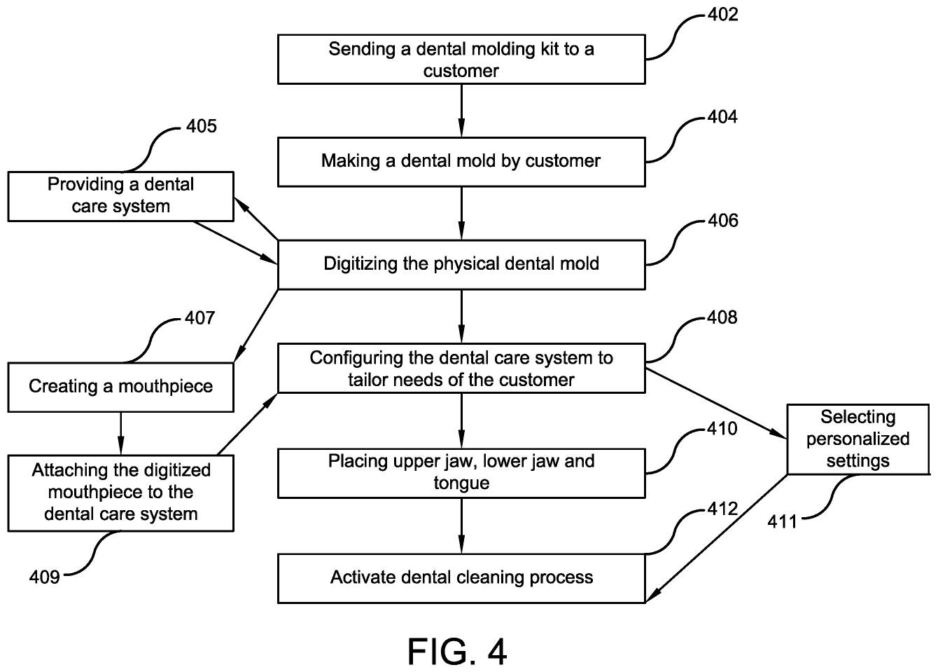

FIG. 4 illustrates a flow diagram depicting a process of use of the comprehensive oral care system 100 of the present invention in accordance with the disclosed specification. As illustrated, initially, a dental molding kit is sent to a customer (Step 402). Then, a physical dental mold is made by the customer by inserting the mold in his or her mouth that provides for the teeth shape, number of teeth, absence of teeth, dental implants, abscesses and other characteristics and contour and shape of teeth (Step 404). After receiving the physical mold from the customer, the physical dental mold is digitized using a scanning computer (Step 406). The digitized form of the dental mold is used by a controller and based on the parameters of the dental mold, one or more of the algorithms are chosen to prepare a personalized dental care routine for the customer (Step 408). Each of the algorithms can be used based on a parameter found within the mouth of the user, e.g., teeth shape, number of teeth, absence of teeth, dental implants, abscesses and other characteristics and contour and shape of teeth.

Once the configuration is done, the dental care system is used by the customer by placing his or her jaw (upper jaw, lower jaw and the tongue) in the respective slots in the mouthpiece (Step 410). After correctly placing the jaw, the dental cleaning process is activated using the touchscreen panel (Step 412). For activation and placing of the jaw, the mouthpiece is extended from the wall-mounted unit and can be adjusted in height as needed. The system 100 eliminates the need to regularly use a separate toothbrush, floss and mouthwash for maintaining a thorough cleaning process and routine for the teeth of the customer. The method may include providing a dental care system at step 405, creating the mouthpiece at step 407 after the step of digitizing and attaching the mouthpiece at step 409 after the step of creating. Personalized settings may be created at step 411 after the step of configuring.

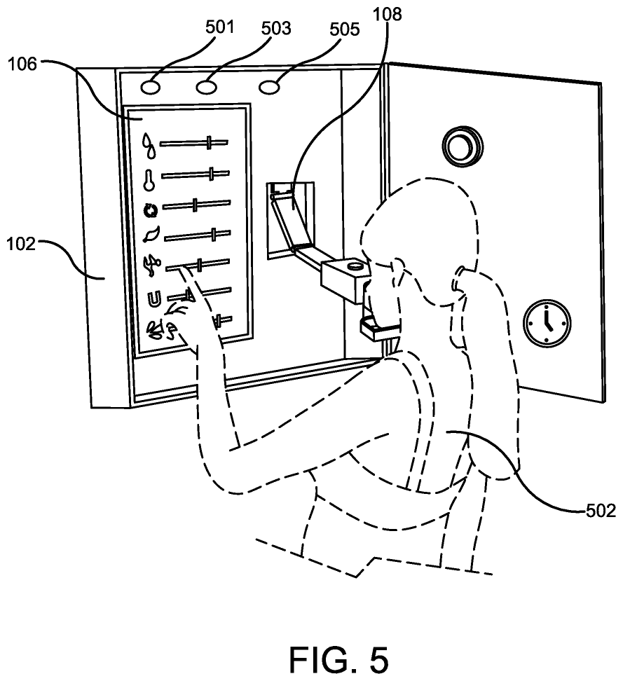

FIG. 5 illustrates a perspective view showing an individual using the comprehensive oral care system 100 of the present invention in accordance with the disclosed specification. An individual 502 using the system 100 for brushing, flossing, and utilizing mouthwash and other dental rinse agents for effective oral care inserts his or her jaw and tongue into the upper jaw portion 112, lower jaw portion 114 and the tongue receptacle 118 when the system 100 is in an extended position (when the arm 108 is extended). Then, the system is activated using the touchscreen panel 106 to dispense toothpaste, water, other rinse agents, mouthwash and combinations thereof. Also, the configuration of the system 100 can be adjusted using the touch panel 106 to meet requirements of the user 502. A series of buttons 501, 503 and 505 may be provided which are pre-sets for different users, such as family members, which will automatically set the various settings to the pre-defined preferences of the user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “comprehensive oral care system”, “system”, “oral care system”, and “dental care system” are interchangeable and refer to the comprehensive oral care system 100 of the present invention.

Notwithstanding the foregoing, the comprehensive oral care system 100 of the present invention can be of any suitable size and configuration as is known in the art without affecting the overall concept of the invention, provided that it accomplishes the above-stated objectives. One of ordinary skill in the art will appreciate that the comprehensive oral care system 100 as shown in the FIGS. are for illustrative purposes only, and that many other sizes and shapes of the comprehensive oral care system 100 are well within the scope of the present disclosure. Although the dimensions of the comprehensive oral care system 100 are important design parameters for user convenience, the comprehensive oral care system 100 be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An oral care system comprising:
a housing having a touch control panel;
an extendable and flexible arm, wherein a first end of the extendable and flexible arm is attached to the housing and a second end of the extendable and flexible arm is comprised of a mouthpiece;
wherein the mouthpiece is comprised of an upper jaw portion, a lower jar portion and a receptacle for receiving a tongue of a user; and
further wherein the mouthpiece is comprised of a plurality of brushes or brush heads and at least one opening for dispensing a fluid.

2. The oral care system as provided in claim 1, wherein each tooth in each of the upper jaw portion and lower jar portion is contacted by at least one of the plurality of brushes or brush heads.

3. The oral care system as provided in claim 2, wherein each tooth is contacted by at least three of the plurality of brushes or brush heads.

4. The oral care system as provided in claim 1, wherein the receptacle comprises at least one brush.

5. The oral care system as provided in claim 1, wherein each of the plurality of brushes or brush heads is adjustable and mounted on a wire.

6. The oral care system as provided in claim 1, wherein the plurality of brushes or brush heads comprise a total of 96 brushes or brush heads.

7. The oral care system as provided in claim 1, wherein the touch control panel comprises at least one of a water pressure control, a temperature control, a brush pressure control, a brush speed control, a toothpaste amount control, a mouthwash amount control and an activation control.

8. The oral care system as provided in claim 1 further comprising a tray connected to the mouthpiece for collecting a fluid or a saliva.

9. The oral care system as provided in claim 1, wherein the mouthpiece can be configured to accommodate at least one of a tooth jaw size, a tooth size, a number of teeth, an absence of teeth, a dental implant, and an abscess.

10. The oral care system as provided in claim 1, wherein the plurality of brushes or brush heads are comprised of a plurality of different characteristics.

11. The oral care system as provided in claim 10, wherein the plurality of different characteristics comprise a degree of hardness, a type of bristle, an arrangement of bristles and a combination thereof.

12. A method of making a personalized oral care system, the method comprising the steps of:
sending a dental mold to a subscriber;
using the dental mold to make an impression;
digitizing the impression made in the dental mold;
configuring a mouthpiece for use in the personalized oral care system;
providing the personalized oral care system; and
attaching the mouthpiece to the personalized oral care system.

13. The method of making a personalized oral care system as recited in claim 12 comprising a further step of placing an upper jaw, a lower jaw and a tongue into the mouthpiece after the step of attaching.

14. The method of making a personalized oral care system as recited in claim 13 comprising a further step of activating the personalized oral care system after the step of placing.

15. The method of making a personalized oral care system as recited in claim 12 comprising a further step of selecting a set of personalized settings after the step of configuring.

16. The method of making a personalized oral care system as recited in claim 12, wherein the mouthpiece is comprised of an upper jaw portion, a lower jaw portion and a receptacle for a tongue of a user.

17. The method of making a personalized oral care system as recited in claim 16, wherein each of the upper jaw portion, the lower jaw portion and the receptacle are provided with a plurality of brushes or brush heads.

18. The method of making a personalized oral care system as recited in claim 15, wherein the step of selecting personalized settings includes, a water pressure control, a temperature control, a brush pressure control, a brush speed control, a toothpaste amount control, a mouthwash amount control and an activation control.

19. A personalized dental care system comprising:
a housing having an interior area, a door, a touch panel and an extendable flexible arm;
a mouthpiece made from a mold impression of a user, the mouthpiece connected to the extendable flexible arm and the mouthpiece having an upper jaw portion, a lower jaw portion and a tongue receptacle;
each of the upper and lower jaw portions having a plurality of brushes and the plurality of brushes are set to engage each tooth positioned in each of the upper jaw portion and lower jar portion; and
the touch panel comprising at least a water pressure control, a temperature control, a brush pressure control, a brush speed control, a toothpaste amount control, a mouthwash amount control and an activation control.

20. The personalized dental care system as recited in claim 19 further comprising a removable tray connected to the mouthpiece and a set of three brushes for each tooth.
